(19) United States
(12) Patent Application Publication
(10) Pub. No.: US 2004/0003650 A1
(43) Pub. Date: Jan. 8, 2004

(54) Device for determining at least one parameter of a medium flowing through a pipe,comprising a filter for receiving harmful substances in said pipe

(76) Inventors: Manfred Strohrmann, Karlsruhe (DE); Thomas Alber, Immenstadt (DE); Manfred Fischer, Oppenweiler (DE); Uwe Konzelmann, Asperg (DE)

Correspondence Address: KENYON & KENYON, ONE BROADWAY, NEW YORK, NY, 10004, US

(21) Appl. No.: 10/343,572

(22) PCT Filed: Apr. 26, 2002
(86) PCT No.: PCT/DE02/01539

(30) Foreign Application Priority Data
Jun. 1, 2001 (DE) 101 26 676.6

(51) Int. Cl. G01M 19/00; B01D 35/02

(52) U.S. Cl. 73/31.05; 73/118.2; 96/417; 73/28.04; 73/31.07

(57) ABSTRACT

A device according to the related art for determining at least one parameter of a medium flowing in a line is unable to prevent pollutants from getting out of the line into the atmosphere. The device of the present invention has a filter which is able to take up the pollutants and thus prevent them from getting into the atmosphere.

### FIELD OF THE INVENTION

The present invention is directed toward a device for determining at least one parameter of a medium flowing in a line, and the use of an activated carbon canister in a device for determining at least one parameter of a medium flowing in a line.

### BACKGROUND INFORMATION

Known devices for determining at least one parameter of a medium flowing in a line have an air filter upstream in the line, the air filter filtering out only liquid and solid particles, however. Pollutants for the atmosphere in the form of gaseous emissions such as hydrocarbon vapors from an induction tract of internal combustion engines which get into the line cannot be absorbed by the air filter.

### SUMMARY OF THE INVENTION

The device of the present invention for determining at least one parameter of a medium flowing in a line and the use according to the invention of an activated carbon canister in a device for determining at least one parameter of a medium flowing in a line have the advantage that in a simple manner pollutants are prevented from escaping from the line into the atmosphere.

Various advantageous variants exist for arranging a filter in the line. First of all, the filter having a specific axial length may be disposed on an inner wall of the line, and may be tubular. However, the filter does not necessarily have to be disposed about the entire periphery of the line, but rather may also be arranged only in sections in the circumferential direction. The ability of a filter to absorb pollutants such as hydrocarbon vapors is a function, inter alia, of its surface, past which the medium flows. Thus, it is possible to decide which variant is practical depending on the application case.

In order not to reduce in size the cross-section of the line in which the medium flows compared to the device without a filter, a depression in which the filter is disposed is advantageously formed in a wall of the line.

The filter may advantageously also be formed as a bar which, for example, has the length of a diameter of the line.

An activated carbon canister or a nonwoven fabric have proven to be advantageous filters.

### BRIEF DESCRIPTION OF THE DRAWINGS

FIG. 1a shows a first exemplary embodiment of a device constructed according to the present invention.

FIG. 1b shows a section in the radial direction along line B-B in FIG. 1a.

FIG. 1c shows a second exemplary embodiment of a device constructed according to the present invention.

FIG. 1d shows a section in the radial direction along line D-D in FIG. 1c.

FIGS. 2a and 2b show a second exemplary embodiment of a device constructed according to the present invention.

### DETAILED DESCRIPTION

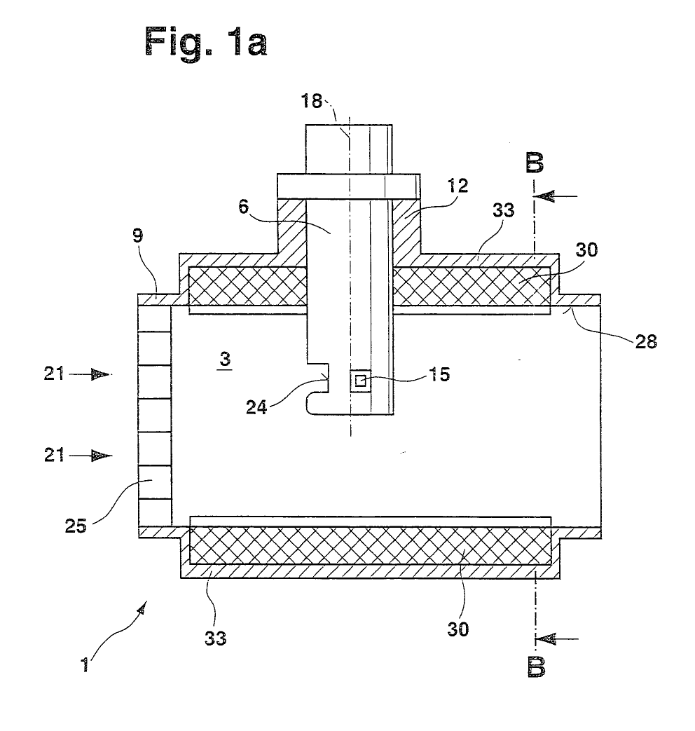

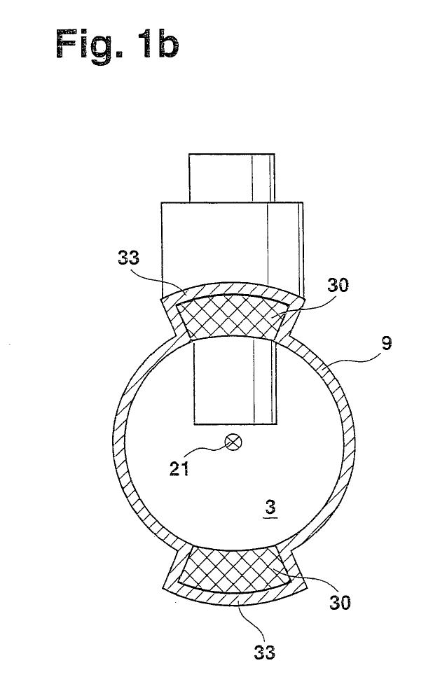

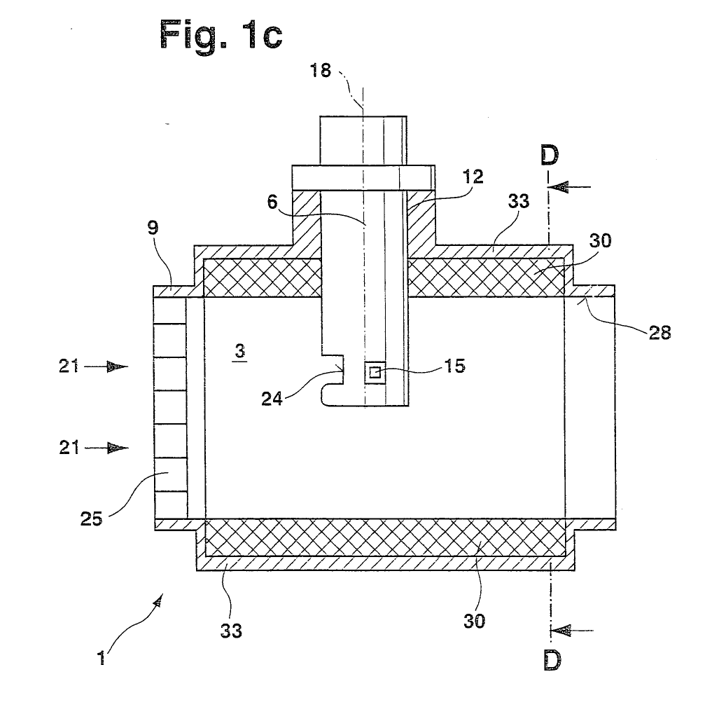

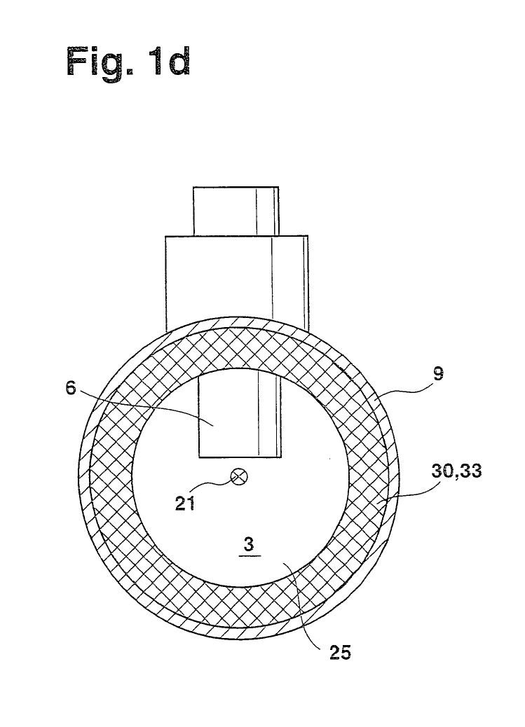

FIG. 1a shows how a device 1 of the present invention, having a line 3 in which the medium flows, is constructed by way of example. Part of device 1 for determining at least one parameter of the flowing medium is a housing 6 which is inserted, for example, in a plug-in manner through an insertion opening 12 into a wall 9 of line 3. Wall 9 delimits a flow cross-section of line 3. For example, in device 1, a measuring element 15, arranged in housing 6, is used which determines, for instance, the volumetric flow of the flowing medium as a parameter. Additional parameters which may be measured are, for example, the pressure, the temperature, a concentration of a medium component or a flow velocity, which are determined using suitable sensors. Housing 6 has in the axial direction a longitudinal axis 18 which, for example, in the mounting direction of housing 6, runs into line 3. The direction of the flowing medium, in the following known as the main flow direction, is indicated in the drawing by corresponding arrows 21, and runs there from left to right. Housing 6 includes a bypass channel (not shown), which, for example, upstream on housing 6 has an entrance aperture 24. The medium flows through entrance aperture 24 into the bypass channel, and there flows past measuring element 15.

Upstream of housing 6, provided in line 3 is, for example, at least one element 25 for influencing the flow. Element 25 is, for example, a flow straightener and/or an element which reroutes liquid or solid particles flowing in the medium in such a way that they do not get into entrance aperture 24 of housing 6.

A filter 30 is disposed, for instance, on an inner wall 28 of line 3 and extends in axial direction 21, for example, upstream and downstream of housing 6. Any other disposition of filter 30 with respect to housing 6 is possible. For example, if line 3 has a circular cross-section, filter 30 is configured, for instance, in the shape of a circle segment and is secured to inner wall 28 of line 3. If the cross-section of line 3 is not to be reduced in size by the filter, then configured in wall 9 of line 3 is at least one depression 33 which accommodates filter 30 so that the cross-section of line 3 upstream and downstream of filter 30 is not altered compared to the device without filter 30.

For example, nonwoven fabric, an activated carbon canister or other known filter types are available as filter materials. Depending on the known emissions, the filter may have the substances which are known to be chemisorptive for them and which filter out the emissions from the line by chemisorption.

During the operation of an internal combustion engine of a motor vehicle, hydrocarbon vapors of a fuel, for instance, may get into an induction tract, line 3 being a part of this induction tract. When the internal combustion engine is in operation, the vaporized hydrocarbons are carried along by the flowing medium into the internal combustion engine and are burned there, so that no harmful emissions are able to develop. However, when the internal combustion engine is shut down, gaseous emissions upstream may get through line 3 into the atmosphere. Filter 30 is provided to prevent this. The gaseous emissions are taken up by filter 30, e.g. are adsorbed or absorbed. During the operation of the internal combustion engine, depending upon the type of filter, for instance, when working with an activated carbon canister, the emissions taken up by filter 30 are released again to the medium flowing past and are burned in the internal combustion engine, so that filter 30 is again completely or at least partially cleaned.

FIG. 1b shows a section in the radial direction along line B-B in FIG. 1a. For simplification, housing 6 and element 25 were not shown here. Two filters 30 are disposed in two depressions 33, the diameter of line 3 not having been reduced in so doing, that is to say, line 3 has no shoulder at this location. Depression 33 and the filter are configured in cross-section with an annular segment shape.

FIG. 1c shows a further exemplary embodiment of device 1 according to the present invention. In comparison to FIG. 1a, filter 30 is tubular, e.g. annular, and is arranged along a circumferential line of line 3. In the same way, depression 33 in the circumferential direction of line 3 is annular. FIG. 1d shows this in a section in the radial direction along line D-D in FIG. 1c.

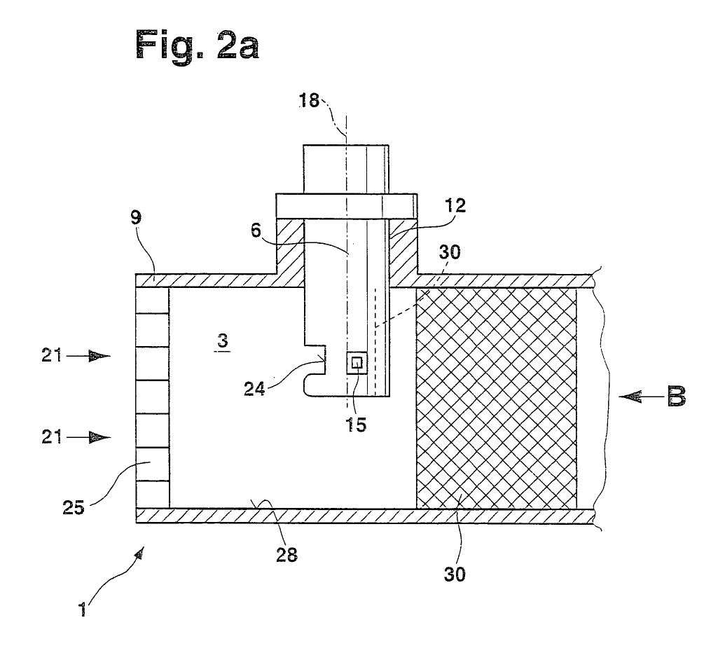

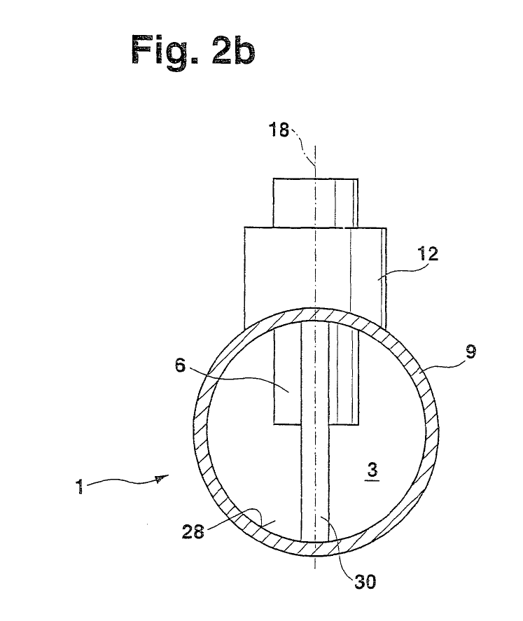

FIG. 2a shows a second exemplary embodiment of device 1 according to the present invention. In this example, filter 30 is arranged as a bar, e.g. rectangular plate, in line 3. In the radial direction, the bar has, for example, the length of the diameter of line 3. In this case, filter 30, constructed as a bar, may take any position in line 3, and may also have shapes deviating from a plate, such as tubular or oval, and may, for instance, also be situated only in the center of line 3.

FIG. 2b shows a view of device 1 of FIG. 2a according to the invention contrary to main flow direction 21. For example, filter 30 is positioned downstream of housing 6. It may also just as well be disposed upstream of housing 6. It is equally possible to secure filter 30 on housing 6, so that with the insertion of housing 6 into wall 9 of line 3, filter 30 is installed and is possibly exchangeable, as indicated in FIG. 2a with a dotted line on the downstream part of housing 6.

What is claimed is:

1. A device for determining at least one parameter of a medium flowing in a line, particularly the intake air mass of an internal combustion engine, having at least one measuring element (15) circumflowed by the flowing medium,
wherein disposed in the line (3) is at least one filter (30) which takes up substances in the line (3) that are damaging to the atmosphere.

2. The device as recited in claim 1,
wherein the filter (30) is disposed on inner wall (28) of the line (3).

3. The device as recited in claim 1,
wherein the line (3) has at least one depression (33) in which the filter (30) is arranged.

4. The device as recited in claim 3,
wherein the depression (33) is configured such that the cross-section of the line (3) upstream and downstream of the filter (30) is the same as in the region of the filter (30).

5. The device as recited in claim 1 or 2,
wherein the filter (30) is tubular.

6. The device as recited in claim 1 or 2,
wherein the filter (30) is segmental.

7. The device as recited in claim 1,
wherein the filter (30) is rectangular.

8. The device as recited in one or more of the preceding claims,
wherein the filter (30) is an activated carbon canister.

9. The device as recited in one or more of the preceding claims,
wherein the filter (30) is a nonwoven fabric.

10. Use of an activated carbon canister (30) in a device (1) for determining at least one parameter of a medium flowing in a line (3), particularly the intake air mass of an internal combustion engine, having at least one measuring element (15) that is circumflowed by the flowing medium, the activated carbon canister being disposed in the line (3) to take up substances which are damaging to the atmosphere.
